(19) United States
(12) Patent Application Publication
(10) Pub. No.: US 2025/0039830 A1
(43) Pub. Date: Jan. 30, 2025

(54) COMMUNICATION METHOD AND RELATED DEVICE

(71) Applicant: GUANGDONG OPPO MOBILE TELECOMMUNICATIONS CORP., LTD., Dongguan, Guangdong (CN)

(72) Inventors: Fei LU, Dongguan, Guangdong (CN); Jianhua LIU, Dongguan, Guangdong (CN)

(21) Appl. No.: 18/728,336

(22) PCT Filed: Oct. 14, 2020
(86) PCT No.: PCT/CN2020/120877

§ 371 Date: Jul. 11, 2024

(51) Int. Cl. H04W 64/00; H04W 60/04; H04W 76/20

(52) U.S. Cl. CPC H04W 64/00; H04W 60/04; H04W 76/20

(57) ABSTRACT

A communication method and a related device are provided. The method includes the following. A mobile management entity (MME) determines first location information of a terminal device during registration, and transmits registration accept information to the terminal device in the case where the first location information matches a management scope of the MME.

### CROSS-REFERENCE TO RELATED APPLICATION(S)

This application is a U.S. National Stage entry of International Application No. PCT/CN2020/120877, filed Oct. 14, 2020, the entire disclosure of which is hereby incorporated by reference.

### TECHNICAL FIELD

Embodiments of the disclosure relate to the field of wireless network communication technologies, and in particular to a communication method and a related device.

### BACKGROUND

Wireless network communication technologies are developing more and more rapidly. At present, in a communication system, in order to be able to access services run by a communication network, the terminal device needs to first register to an access and mobility management function (AMF) entity in the communication network and then performs a location service (LCS) after registration is completed. However, in a non-terrestrial communication system, such as in a satellite network, it is necessary to first select a terrestrial receiving station (which may also be referred to as an AMF) to serve communication between the terminal device and a satellite. One satellite can cover multiple countries. Due to communication coverage of satellites, a terminal device in one country may be in coverage of multiple satellites. Therefore, when the terminal device performs the LCS after the terminal device registers to the AMF, the terminal device may find that a satellite which the AMF can serve is not one of satellites to which the terminal device can be connected. In this case, the terminal device needs to initiate registration again. With such registration manner, reliability of communication between the terminal device and the satellite may be affected, and communication quality of the terminal device may also be affected.

### SUMMARY

A communication method and a related device are provided in embodiments of the disclosure.

In a first aspect, a communication method is provided in embodiments of the disclosure. The method is applied to a mobile management entity (MME) and includes the following. Determine first location information of a terminal device during registration. Transmit registration accept information to the terminal device in the case where the first location information matches a management scope of the MME.

In a second aspect, an MME is provided in embodiments of the disclosure. The MME includes a transceiver, a processor coupled to the transceiver, and a memory storing a computer program which, when executed by the processor, causes the MME to determine first location information of a terminal device during registration, and transmit registration accept information to the terminal device in the case where the first location information matches a management scope of the MME.

In a third aspect, a terminal device is provided in embodiments of the disclosure. The terminal device includes a transceiver, a processor coupled to the transceiver, and a memory storing a computer program which, when executed by the processor, causes the terminal device to transmit first location information of the terminal device to an MME during registration, where the first location information is used to determine whether the first location information matches a management scope of the MME; and receive registration accept information transmitted by the MME.

Other features and aspects of the disclosed features will become apparent from the following detailed description, taken in conjunction with the accompanying drawings, which illustrate, by way of example, the features in accordance with embodiments of the disclosure. The summary is not intended to limit the scope of any embodiment described herein.

### BRIEF DESCRIPTION OF THE DRAWINGS

In order to illustrate technical solutions in embodiments of the disclosure more clearly, accompanying drawings required for describing embodiments are briefly introduced below.

FIG. 1a is a schematic diagram illustrating an architecture of a location service (LCS) in a communication network provided in embodiments of the disclosure.

FIG. 1b is a schematic flow chart illustrating registration provided in embodiments of the disclosure.

FIG. 1c is a schematic diagram illustrating communication coverage of satellites in a satellite network provided in embodiments of the disclosure.

FIG. 2 is a schematic flow chart illustrating a communication method provided in embodiments of the disclosure.

FIG. 3 is another schematic flow chart illustrating a communication method provided in embodiments of the disclosure.

FIG. 4 is yet another schematic flow chart illustrating a communication method provided in embodiments of the disclosure.

FIG. 5 is yet another schematic flow chart illustrating a communication method provided in embodiments of the disclosure.

FIG. 6 is a schematic structural diagram illustrating a communication apparatus provided in embodiments of the disclosure.

FIG. 7 is another schematic structural diagram illustrating a communication apparatus provided in embodiments of the disclosure.

FIG. 8 is yet another schematic structural diagram illustrating a communication apparatus provided in embodiments of the disclosure.

FIG. 9 is a schematic structural diagram illustrating a mobile management entity (MME) provided in embodiments of the disclosure.

FIG. 10 is a schematic structural diagram illustrating a terminal device provided in embodiments of the disclosure.

FIG. 11 is a schematic structural diagram illustrating a location management entity provided in embodiments of the disclosure.

### DETAILED DESCRIPTION

Technical solutions in embodiments of the disclosure will be described clearly and in detail below with reference to accompanying drawings in embodiments of the disclosure.

In a communication system, in order to be able to access a service(s) run by a communication network, a terminal device may first register to the communication network, and after registration succeeds, the terminal device can access the service(s) run by the communication network. Optionally, during registration, the terminal device may transmit registration request information to a mobile management entity (MME) via an access entity. In the case where the MME receives the registration request information from the terminal device, the MME may transmit registration accept information to the terminal device to complete registration initiated by the terminal device. The registration request information transmitted to the MME from the terminal device may carry location information of the terminal device. After the MME obtains the location information of the terminal device, the MME may determine whether the terminal device at the current location is in a management scope of the MME according to the location information. In the case where the MME determines that the terminal device at the current location is in the management scope of the MME, the MME may transmit the registration accept information to the terminal device to complete registration initiated by the terminal device. Optionally, the location information of the terminal device carried in the registration request information received by the MME may be first location information or second location information. In the case where the location information received by the MME is the first location information, the MME may determine whether the terminal device at the current location is in the management scope of the MME according to the first location information. In the case where the location information received by the MME is the second location information, the MME may transmit the second location information to a location management entity. In this case, the location management entity may receive the second location information, determine the first location information according to the second location information, and transmit the first location information to the MME. The MME may determine whether the terminal device at the current location is in the management scope of the MME according to the first location information received.

It may be noted that the access entity in embodiments of the disclosure may be an entity supporting a function of accessing a communication network. For example, the access entity may be a radio access network (RAN), or may be referred to as other expressions, or may be other entities having the function. The MME may be an access and mobility management function (AMF), or may be referred to as other expressions, or may be other entities having a mobility management function. The location management entity may be a location management function (LMF), or may be referred to as other expressions, or may be other entities having the LMF.

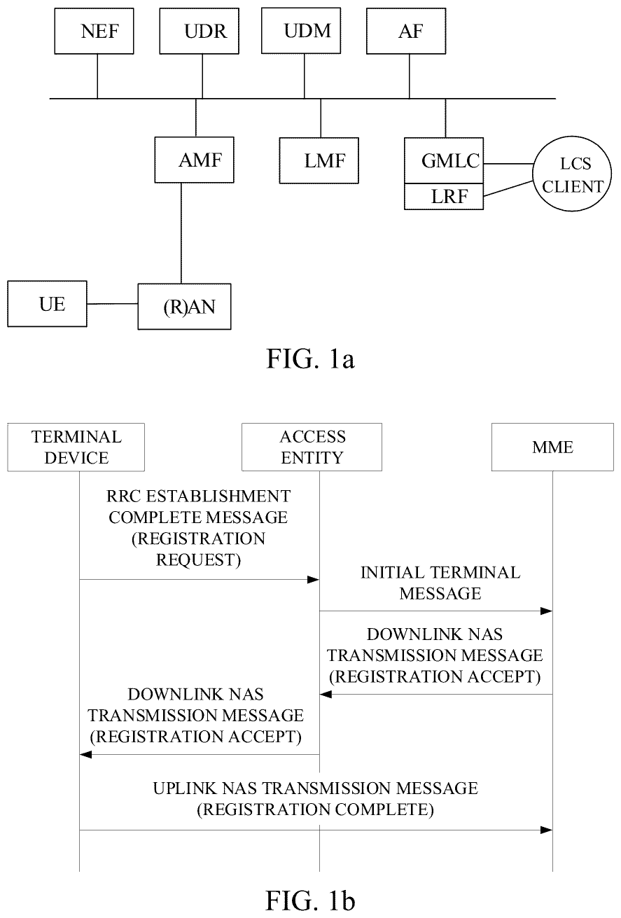

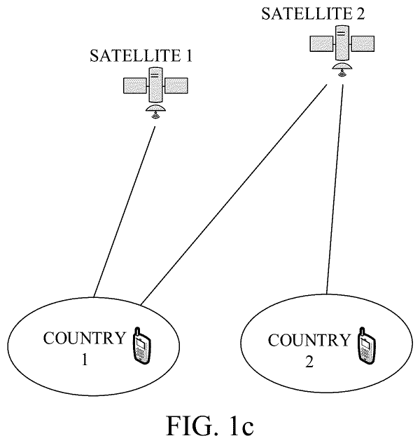

Referring to FIG. 1a, where FIG. 1a is a schematic diagram illustrating an architecture of a location service (LCS) in a communication network provided in embodiments of the disclosure. Functions of network elements in the architecture of the LCS in the communication network are described below.

Terminal device (user equipment (UE)): the terminal device accesses a 5th generation (5G) network and obtains services mainly via a radio air interface. The terminal device performs information interaction with a base station via an air interface, and performs information interaction with an AMF through non-access stratum (NAS) signaling.

RAN: the RAN is responsible for air-interface resource scheduling and air-interface connection management for network access of the terminal device.

AMF: the AMF is a core-network control-plane entity. The AMF is mainly responsible for user mobility management including: registration and temporary identity (ID) allocation, maintenance of an idle state and a connected state and state transition, handover in a connected state, triggering paging in an idle state of a user, and other functions.

Unified data management (UDM): the UDM is a core-network control-plane entity and is a home subscriber server (HSS). The UDM stores permanent subscriber data and has a function of generation of authentication and terminal identification generation.

Network exposure function (NEF): the NEF has a capability to provide a specific service to a third party and provide a network service to an external party, e.g., network optimization, function enhancement, etc.

Unified data repository (UDR): the UDR can store and retrieve subscription data.

As illustrated in FIG. 1a, the network elements in the architecture of the LCS in the communication network may further include: an LMF, an LCS client, an application function (AF), a gateway mobile location center (GMLC), and a location retrieval function (LRF).

FIG. 1b is a schematic flow chart illustrating registration initiated by a terminal device. In some possible implementations, as can be seen from FIG. 1b, a terminal device may first transmit a radio resource control (RRC) establishment complete message to an access entity. The RRC establishment complete message may carry registration request information. The registration request information carries location information of the terminal device. The location information may be a tracking area identity (TAI) for the terminal device, a cell global identifier (CGI), etc. After the access entity receives the RRC establishment complete message, the access entity may obtain the registration request information in the RRC establishment complete message. The access entity may transmit the registration request information to an MME, and the registration request information may be carried in an initial terminal message transmitted to the MME from the access entity. After the access entity transmits the initial terminal message to the MME, the MME may receive the registration request information transmitted by the access entity. After the MME receives the registration request information from the terminal device, the MME may accept registration initiated by the terminal device and transmit registration accept information to the terminal device. Optionally, the registration accept information may be carried in a downlink NAS transmission message transmitted to the access entity from the MME. The registration accept information may include, for example, a temporary terminal ID. For example, the temporary terminal ID may be a 5G globally unique temporary UE ID (5G-GUTI). After the access entity receives the registration accept information, the access entity may transmit the downlink NAS transmission message carrying the registration accept information to the terminal device, and the terminal device may receive the registration accept information. After the terminal device receives the registration accept information, the terminal device may return an uplink NAS transmission message carrying registration complete information to the MME. The registration complete information is used to confirm that the temporary terminal ID, e.g., a 5G-GUTI, is valid.

It can be seen that during registration, the MME receives only the registration request information including the location information transmitted by the terminal device, and does not make further determination according to the location information, for example, does not determine whether the terminal device is in a management scope of the MME. Instead, the MME performs an LCS according to the location information after registration is completed. With such registration manner, it may result in that the terminal device at the current location is not in the management scope of the MME to which the terminal device performs registration, and thus it may result in that the terminal device needs to initiate registration again, and thus communication reliability of the terminal device is affected, and communication quality of the terminal device may be affected.

In some possible implementations, in a non-terrestrial communication network, such as in a satellite network, one satellite can cover multiple countries due to communication coverage of satellites. FIG. 1c is a schematic diagram illustrating communication coverage of satellites in a satellite network. In FIG. 1c, satellite 2 can cover multiple countries, for example, satellite 2 covers both country 1 and country 2, but satellite 1 covers only country 1. As can be seen from FIG. 1c, in the case where the terminal device is in country 1, the terminal device is in communication coverage of satellite 1 and communication coverage of satellite 2. However, in the case where no terrestrial receiving station (which may also be referred to as an MME) serving the terminal device is in country 1 covered by satellite 1, the terminal device is unable to select a core network (which may also be referred to as an MME) for country 1, which is not in line with policy regulation and legal sensing requirements (this is because that when the terminal device is in a country, the terminal device needs to select an MME in the country). At present, generally, the terminal device performs an LCS after registration initiated by the terminal device is completed, which may result in that during registration, it is impossible to verify, according to the location information of the terminal device, whether the terminal device has selected a correct MME to serve communication between the terminal device and the satellite, in other words, it is impossible to determine whether the terminal device has selected a correct public land mobile network (PLMN) for the satellite to serve the terminal device. In the case where the terminal device registers to the MME, but finds, during an LCS performed after registration is completed, that a satellite that the MME selected by the terminal device can serve is not one of satellites to which the terminal device can be connected, the terminal device needs to initiate registration again until the terminal device finds that a satellite to which the terminal device can be connected is one of satellites which the MME can serve. With such registration manner, communication reliability of the terminal device may be affected, and communication quality of the terminal device may also be affected.

It may be understood that a system to which the technical solutions in embodiments of the disclosure may be applied includes registration processes in a terrestrial communication system and a non-terrestrial communication system. A communication method and a related device are provided in embodiments of the disclosure, which guarantees communication reliability and communication quality of a terminal device. The communication method and the related device are respectively described in detail below.

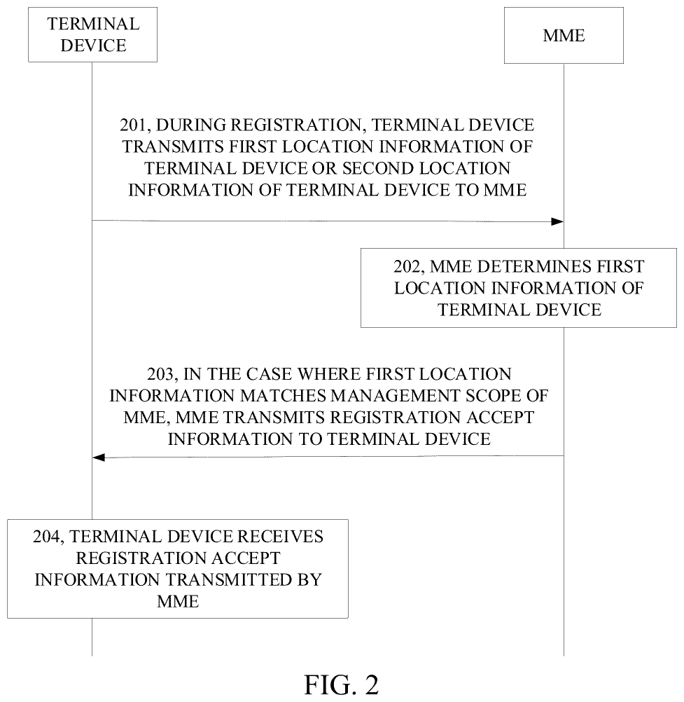

Refer to FIG. 2, where FIG. 2 is a schematic flow chart illustrating a communication method provided in embodiments of the disclosure. The method in embodiments includes the following.

At 201, during registration, a terminal device transmits first location information of the terminal device or second location information of the terminal device to an MME.

In some possible embodiments, in order to be able to access a service(s) run by a certain communication network, the terminal device may first register to the communication network, and after registration succeeds, the terminal device can access the service(s) run by the communication network. During registration, the terminal device may transmit the first location information or the second location information of the terminal device to the MME, to enable that the MME may subsequently determine, according to the first location information of the terminal device, whether to accept registration initiated by the terminal device.

Optionally, during registration, the terminal device may transmit the first location information of the terminal device to the MME, or transmit the second location information of the terminal device to the MME. The first location information may be a TAI, a CGI, a mobile country code (MCC), etc. The second location information may be geographic location information, specifically, latitude, longitude, and the like of the terminal device.

In some possible implementations, in the case where the terminal device is to access a service(s) run by a non-terrestrial communication network, the terminal device may further transmit at least one satellite ID to the MME. The satellite ID indicates a satellite to which the terminal device can perform communication connection. The satellite ID may be a number, a bit value (bit), or other information, which is not limited herein.

At 202, the MME determines the first location information of the terminal device.

In some possible implementations, in the case where the terminal device transmits the second location information of the terminal device to the MME during registration, the MME can determine the first location information of the terminal device according to the second location information transmitted by the terminal device. Optionally, a specific implementation in which the MME determines the first location information according to the second location information may include the following. The MME transmits the second location information to a location management entity, and after the location management entity receives the second location information, the location management entity parses the second location information to obtain the first location information of the terminal device. The first location information may indicate the current geographic location of the terminal device, for example, a geographic location of the terminal device may be indicated via longitude, latitude, elevation, etc. After the location management entity determines the first location information of the terminal device according to the second location information, the location management entity may transmit the first location information to the MME. The MME receives the first location information, which means that the MME has determined the first location information of the terminal device.

In some possible implementations, the specific implementation in which the MME determines the first location information according to the second location information may further include the following. The MME transmits a first service message to the location management entity. The first service message may be, for example, a Namf_Communication_NlMessageNotify message. The first service message may carry an uplink positioning container, and the uplink positioning container may carry the second location information of the terminal device. The location management entity receives the first service message transmitted by the MME, which means that the location management entity has obtained the second location information of the terminal device. After the location management entity obtains the second location information of the terminal device, the location management entity may parse the second location information to obtain the first location information of the terminal device. The location management entity may transmit the first location information to the MME. For example, the location management entity may transmit a second service message to the MME, where the second service message may be a Nlmf_Location_DetermineLocation message. The second service message may carry the first location information of the terminal device. The MME receives the second service message transmitted by the location management entity, which means that the MME has determined the first location information of the terminal device.

In some possible embodiments, in the case where the terminal device transmits the first location information of the terminal device to the MME during registration, the MME receives the first location information transmitted by the terminal device, which means that the MME has determined the first location information of the terminal device. The first location information may indicate the current geographic location of the terminal device, for example, the geographic location of the terminal device may be indicated via longitude, latitude, elevation, etc. The first location information may alternatively be an MMC of a cellular network in which the terminal device is currently located.

At 203, in the case where the first location information matches a management scope of the MME, the MME transmits registration accept information to the terminal device.

In some possible implementations, after the MME determines the first location information of the terminal device, the MME can determine whether the first location information matches the management scope of the MME. In the case where the first location information matches the management scope of the MME, it is indicated that the terminal device can access a service run by a communication network in which the MME is located. The MME can accept registration initiated by the terminal device and transmit the registration accept information to the terminal device, where the registration accept information indicates that registration has been accepted. Optionally, the registration accept information may be carried in a downlink NAS transmission message, that is, the MME can transmit the downlink NAS transmission message to the terminal device via the access entity. The downlink NAS transmission message carries the registration accept information. The registration accept information may include a temporary terminal ID, a registration area, etc. For example, the temporary terminal ID may be a 5G-GUTI.

In some possible implementations, in the case where the terminal device is to access a service(s) run by a non-terrestrial communication network, for example, in the case where the non-terrestrial communication network is a satellite communication network, the MME may receive at least one satellite ID transmitted by the terminal device besides the first location information or the second location information transmitted by the terminal device. The satellite ID indicates a satellite to which the terminal device can perform communication connection. In the case where the MME determines, according to the first location information, that the terminal device matches the management scope of the MME, the MME further needs to determine whether a satellite to which the terminal device can be connected is one of satellites that the MME can serve. In the case where the MME determines that the satellite to which the terminal device can be connected is one of satellites that the MME can serve, the MME may transmit the registration accept information to the terminal device.

Optionally, a specific implementation in which the MME determines whether the satellite to which the terminal device can be connected is one of satellites that the MME can serve may be described as follows. The MME may pre-store an ID of a satellite that the MME can serve, where the ID of the satellite that the MME can serve may be implemented as one or more IDs. During registration, the MME may receive an ID of the satellite to which the terminal device can be connected transmitted by the terminal device, where the ID of the satellite to which the terminal device can be connected may implemented as one or more IDs. The MME determines whether the pre-stored ID of the satellite that the MME can serve matches the ID of the satellite to which the terminal device can be connected transmitted by the terminal device. In the case where the ID of the satellite to which the terminal device can be connected transmitted by the terminal device matches the pre-stored ID of the satellite that the MME can serve, it is indicated that the satellite to which the terminal device can be connected is one of satellites that the MME can serve.

At 204, the terminal device receives the registration accept information transmitted by the MME.

In some possible implementations, after the MME transmits the registration accept information to the terminal device, the terminal device may receive the registration accept information. Optionally, the terminal device may receive the downlink NAS transmission message carrying the registration accept information transmitted by the MME via the access entity. After the terminal device receives the registration accept information, the terminal device may return an uplink NAS transmission message carrying registration complete information to the MME. The registration complete information is used to confirm that the temporary terminal ID, e.g., a 5G-GUTI, is valid.

In embodiments of the disclosure, during registration, the terminal device may transmit the first location information of the terminal device to the MME; or the terminal device may transmit the second location information of the terminal device, and the MME may determine the first location information of the terminal device according to the second location information. In the case where the first location information matches the management scope of the MME, the MME may transmit the registration accept information to the terminal device. Furthermore, the terminal device may receive the registration accept information transmitted by the MME. With implementation of the above method, the terminal device may provide the location information of the terminal device to the MME during registration, to enable that the MME can determine whether the terminal device is in the management scope of the MME according to the location information, which may effectively guarantee communication reliability and communication quality of the terminal device.

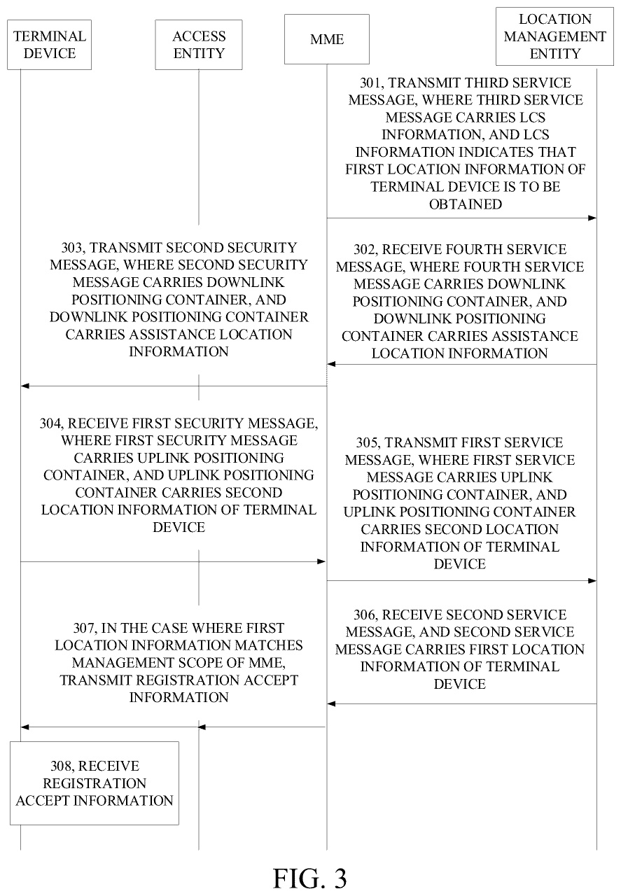

Refer to FIG. 3, where FIG. 3 is another schematic flow chart illustrating a communication method provided in embodiments of the disclosure. The method in embodiments includes the following.

At 301, an MME transmits a third service message to a location management entity. The third service message carries LCS information, and the LCS information indicates that first location information of a terminal device is to be obtained.

In some possible implementations, during registration, the MME may transmit the LCS information to the location management entity. Optionally, the MME may transmit the third service message to the location management entity. For example, the third service message may be a Nlmf_Location_DetermineLocation message. The third service message carries the LCS information. The LCS information may be an LCS associated ID, where the ID is an ID of the terminal device. The LCS information indicates that the MME needs to obtain the first location information of the terminal device from the location management entity.

In some possible implementations, before the MME transmits the third service message to the location management entity, the terminal device may initiate registration. During registration, the terminal device may transmit registration request information to the MME, to enable that after the MME receives the registration request information transmitted by the terminal device, the MME can request to obtain the first location information of the terminal device by transmitting the third service message to the location management entity. The registration request information may include a terminal ID, where the terminal ID is a number, a bit value (bit), or other information, which is not limited herein. Optionally, the terminal device may first transmit an RRC establishment complete message to an access entity. The RRC establishment complete message carries the registration request information. After the access entity receives the RRC establishment complete message, the access entity may obtain the registration request information in the RRC establishment complete message. The access entity may transmit the registration request information to the MME, and the registration request information may be carried in an initial terminal message transmitted to the MME from the access entity. After the access entity transmits the initial terminal message to the MME, the MME may receive the registration request information transmitted by the access entity. Optionally, the MME may determine, according to the registration request information, that the terminal device needs to perform communication connection to a satellite. That is, it is determined that the terminal device needs to first connect to a terrestrial communication network (which may also be referred to as a terrestrial receiving station), to enable that the terrestrial receiving station can serve the communication between the terminal device and the satellite.

In some possible implementations, the registration request information may further include a registration type. The registration type may be any one of initial registration, mobility registration update, and periodic registration. The mobility registration update may mean that the terminal device needs to initiate mobility registration update once the terminal device moves to a new tracking area (TA) cell that does not belong to the current registration area for the terminal device. The periodic registration may mean that the terminal device is triggered to initiate periodic registration in response to expiration of a periodic registration timer.

In some possible implementations, in the case where the terminal device is to access a service(s) run by a non-terrestrial communication network, the registration request information transmitted to the MME from the terminal device may further include at least one satellite ID. The satellite ID indicates a satellite to which the terminal device can perform communication connection. After the MME receives the registration request information, the MME may determine that the terminal device needs to perform communication connection to the satellite. That is, it is determined that the terminal device needs to first connect to a terrestrial receiving station (which may also be referred to as an MME), to enable that the terrestrial receiving station can serve the communication between the terminal device and the satellite. The satellite ID may be a number, a bit value (bit), or other information, which is not limited herein.

In some possible implementations, considering that the MME may be implemented as one or more MMEs, the access entity needs to select an MME from the one or more MMEs and transmit the registration request information to the selected MME. Optionally, the access entity may select an MME corresponding to the terminal ID from the one or more MMEs and transmit the registration request information to the selected MME. Optionally, the access entity may select any one MME from the one or more MMEs and transmit the registration request information to the selected MME.

At 302, the MME receives a fourth service message transmitted by the location management entity. The fourth service message carries a downlink positioning container, and the downlink positioning container carries assistance location information.

In some possible implementations, the location management entity receives the third service message transmitted by the MME, which means that the location management entity has determined that the MME is to obtain the first location information of the terminal device. The location management entity may transmit the assistance location information to the MME, to enable that the MME can transmit the assistance location information to the terminal device in subsequent operations. Therefore, the terminal device can determine second location information of the terminal device according to the assistance location information, which in turn enables the MME to determine the first location information.

In some possible implementations, the location management entity may transmit the fourth service message to the MME. For example, the fourth service message may be a Namf_Communication_NIN2MessageTransfer message. The fourth service message may carry the downlink positioning container, and the downlink positioning container may carry the assistance location information. After the location management entity transmits the fourth service message to the MME, the MME can receive the fourth service message transmitted by the location management entity.

At 303, the MME transmits a second security message to the terminal device. The second security message carries the downlink positioning container, and the downlink positioning container carries the assistance location information.

In some possible implementations, before the MME transmits the second security message to the terminal device, an authentication process between the MME and the terminal device may be performed to determine whether the terminal device is legal and further to determine whether a communication network corresponding to the MME which the terminal device is to access is trustworthy. During authentication between the MME and the terminal device, a partial security context may be generated.

In some possible implementations, after authentication between the MME and the terminal device passes, the MME may transmit the assistance location information to the terminal device to enable that the terminal device determines the second location information according to the assistance location information. Optionally, a specific implementation in which the MME transmits the assistance location information to the terminal device may be that the MME transmits the second security message to the terminal device. For example, the second security message may be a security mode command message. The second security message may carry the downlink positioning container, and the downlink positioning container carries the assistance location information. Optionally, the security mode command message may be used to notify the terminal device to transfer the partial security context generated during authentication to a full security context.

At 304, the MME receives a first security message transmitted by the terminal device. The first security message carries an uplink positioning container, and the uplink positioning container carries the second location information of the terminal device.

In some possible implementations, the terminal device may receive the second security message transmitted by the MME. The second security message carries the downlink positioning container, and the downlink positioning container carries the assistance location information. After the terminal device receives the second security message transmitted by the MME, the terminal device may determine the second location information of the terminal device according to the assistance location information in the second security message. Optionally, the second location information may be a TAI for the terminal device, a CGI, etc. After the terminal device determines the second location information, the terminal device may transmit the second location information to the MME, to enable that the MME receives the second location information transmitted by the terminal device. Specifically, the terminal device may transmit the first security message to the MME. For example, the first security message may be a security mode complete message. The first security message may carry the uplink positioning container, and the uplink positioning container carries the second location information of the terminal device. After the terminal device transmits the first security message to the MME, the MME may receive the first security message transmitted by the terminal device, which means that the MME has obtained the second location information of the terminal device.

At 305, the MME transmits a first service message to the location management entity. The first service message carries the uplink positioning container, and the uplink positioning container carries the second location information of the terminal device.

In some possible implementations, the MME receives the first security message transmitted by the terminal device, which means that the MME has obtained the second location information of the terminal device. After the MME obtains the second location information, the MME may transmit the second location information to the location management entity. Optionally, the MME may transmit the first service message to the location management entity. For example, the first service message may be a Namf_Communication_NIMessageNotify message. The first service message may carry the uplink positioning container, and the uplink positioning container carries the second location information of the terminal device.

At 306, the MME receives a second service message transmitted by the location management entity, and the second service message carries the first location information of the terminal device.

In some possible implementations, after the MME transmits the first service message to the location management entity, the location management entity may obtain the second location information of the terminal device carried in the first service message. After the location management entity obtains the second location information of the terminal device, the location management entity may parse the second location information to obtain the first location information of the terminal device. The first location information may indicate the current geographic location of the terminal device, for example, the current geographic location of the terminal device may be indicated via longitude, latitude, elevation, etc. After the location management entity determines the first location information of the terminal device, the location management entity may transmit the first location information to the MME, to enable that the MME receives the first location information. Optionally, the location management entity may transmit the second service message to the MME. For example, the second service message may be a Nlmf_Location_DetermineLocation message. The second service message carries the first location information of the terminal device. After the location management entity transmits the second service message to the MME, the MME may receive the second service message transmitted by the location management entity, which means that the MME has obtained the first location information carried in the second service message.

At 307, in the case where the first location information matches a management scope of the MME, the MME transmits registration accept information to the terminal device.

At 308, the terminal device receives the registration accept information transmitted by the MME.

For specific implementations of the operations at 307 and 308, reference can be made to the specific illustration of the operations at 203 and 204 in the above embodiments, which are not repeated herein.

In embodiments of the disclosure, the MME may transmit the third service message to the location management entity. The third service message carries the LCS information, and the LCS information indicates that the first location information of the terminal device is to be obtained. The location management entity transmits the fourth service message to the MME, and the MME may receive the fourth service message transmitted by the location management entity. The fourth service message carries the downlink positioning container, and the downlink positioning container carries the assistance location information. The MME transmits the second security message to the terminal device. The second security message carries the downlink positioning container, and the downlink positioning container carries the assistance location information. The terminal device may determine the second location information according to the assistance location information, and the MME may receive the first security message transmitted by the terminal device. The first security message carries the uplink positioning container, and the uplink positioning container carries the second location information of the terminal device. The MME may transmit the first service message to the location management entity, the first service message carries the uplink positioning container, and the uplink positioning container carries the second location information of the terminal device. Furthermore, the MME may receive the second service message transmitted by the location management entity, and the second service message carries the first location information of the terminal device. In the case where the first location information matches the management scope of the MME, the MME transmits the registration accept information to the terminal device. The terminal device may receive the registration accept information transmitted by the MME to complete registration. With implementation of the above method, the terminal device may provide location information of the terminal device to the MME during registration, so that the MME may determine whether the terminal device is in the management scope of the MME according to the location information, which may effectively guarantee communication reliability and communication quality of the terminal device.

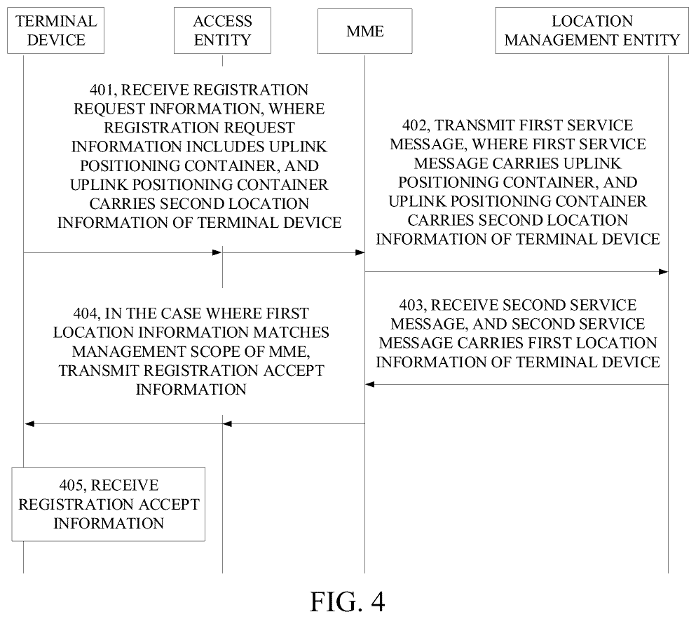

Refer to FIG. 4, where FIG. 4 is yet another schematic flow chart illustrating a communication method provided in embodiments of the disclosure. The method in embodiments includes the following.

At 401, an MME receives registration request information transmitted by a terminal device. The registration request information includes an uplink positioning container, and the uplink positioning container carries second location information of the terminal device.

In some possible implementations, the terminal device may initiate registration. During registration, the terminal device may transmit the registration request information to the MME, to enable that the MME receives the registration request information transmitted by the terminal device. The registration request information may include a terminal ID and a registration type. Optionally, the terminal device may first transmit an RRC establishment complete message to an access entity. The RRC establishment complete message carries the registration request information. After the access entity receives the RRC establishment complete message, the access entity may obtain the registration request information in the RRC establishment complete message. The access entity may transmit the registration request information to the MME, and the registration request information may be carried in an initial terminal message transmitted to the MME from the access entity. After the access entity transmits the initial terminal message to the MME, the MME may receive the registration request information transmitted by the access entity. For a manner in which the access entity selects the MME, reference can be made to the related illustration in the operation at 301, which is not repeated herein.

In some possible implementations, the registration request information above may include the uplink positioning container, and the uplink positioning container carries the second location information of the terminal device. The second location information may be a TAI for the terminal device, a CGI, etc. Optionally, the second location information may be determined by the terminal device according to assistance location information in a downlink positioning container pre-stored by the terminal device.

In some possible implementations, in the case where the terminal device is to access a service(s) run by a non-terrestrial communication network, the registration request information may further include at least one satellite ID. The satellite ID indicates a satellite to which the terminal device can perform communication connection. The satellite ID may be a number, a bit value (bit), or other information, which is not limited herein.

At 402, the MME transmits a first service message to a location management entity. The first service message carries the uplink positioning container, and the uplink positioning container carries the second location information of the terminal device.

At 403, the MME receives a second service message transmitted by the location management entity, and the second service message carries first location information of the terminal device.

At 404, in the case where the first location information matches a management scope of the MME, the MME transmits registration accept information to the terminal device.

At 405, the terminal device receives the registration accept information transmitted by the MME.

For specific implementations of the operations at 402 to 405, reference can be made to the specific illustration of the operations at 305 to 308 in the above embodiments, which is not repeated herein.

In embodiments of the disclosure, the MME may receive the registration request information transmitted by the terminal device. The registration request information may include the uplink positioning container, and the uplink positioning container carries the second location information of the terminal device. After the MME receives the second location information, the MME may transmit the first service message to the location management entity. The first service message carries the uplink positioning container, and the second location information is carried in the uplink positioning container. After the location management entity receives the second location information, the location management entity may determine the first location information according to the second location information. The MME may receive the second service message transmitted by the location management entity, and the second service message carries the first location information of the terminal device. In the case where the first location information matches a management scope of the MME, the MME may transmit the registration accept information to the terminal device, and the terminal device may receive the registration accept information transmitted by the MME to complete registration. With implementation of the above method, the terminal device may provide location information of the terminal device to the MME during registration, so that the MME may determine whether the terminal device is in the management scope of the MME according to the location information, which may effectively guarantee communication reliability and communication quality of the terminal device.

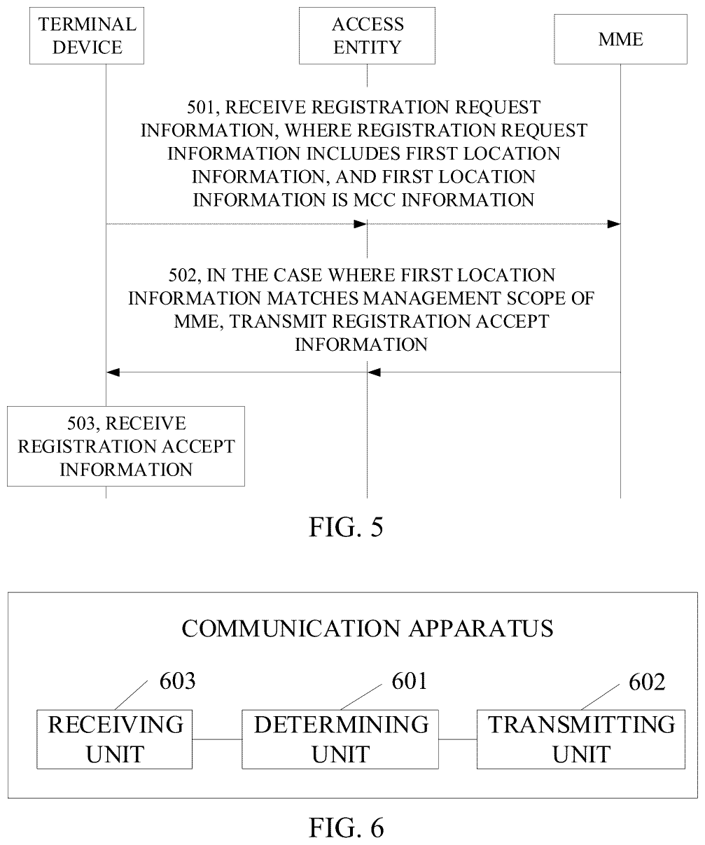

Refer to FIG. 5, where FIG. 5 is yet another schematic flow chart illustrating a communication method provided in embodiments of the disclosure. The method in embodiments includes the following.

At 501, an MME receives registration request information transmitted by a terminal device. The registration request information includes first location information, and the first location information is MCC information.

In some possible implementations, the terminal device may initiate registration. During registration, the terminal device may transmit the registration request information to the MME, to enable that the MME receives the registration request information transmitted by the terminal device. The registration request information may include a terminal ID and a registration type. Optionally, the terminal device may first transmit an RRC establishment complete message to an access entity. The RRC establishment complete message carries the registration request information. After the access entity receives the RRC establishment complete message, the access entity may obtain the registration request information in the RRC establishment complete message. The access entity may transmit the registration request information to the MME, and the registration request information may be carried in an initial terminal message transmitted to the MME from the access entity. After the access entity transmits the initial terminal message to the MME, the MME may receive the registration request information transmitted by the access entity. For a manner in which the access entity selects the MME, reference can be made to the related illustration in the operation at 301, which is not repeated herein.

In some possible implementations, the registration request information may include the first location information, and the first location information may be an MCC information. Optionally, the MCC information may be an MCC of a cellular network in which the terminal device is currently located.

In some possible implementations, in the case where the terminal device is to access a service(s) run by a non-terrestrial communication network, the registration request information may further include at least one satellite ID. The satellite ID indicates a satellite to which the terminal device can perform communication connection. The satellite ID may be a number, a bit value (bit), or other information, which is not limited herein.

At 502, in the case where the first location information matches a management scope of the MME, the MME transmits registration accept information to the terminal device.

At 503, the terminal device receives the registration accept information transmitted by the MME.

For specific implementations of the operations at 502 and 503, reference can be made to the specific illustration of the operations at 203 and 204 in the above embodiments, which is not repeated herein.

In embodiments of the disclosure, the MME may receive the registration request information transmitted by the terminal device. The registration request information may include the first location information, and the first location information is an MCC information. In the case where the first location information matches the management scope of the MME, the MME may transmit the registration accept information to the terminal device. Furthermore, the terminal device may receive the registration accept information transmitted by the MME to complete registration. With implementation of the above method, the terminal device may provide location information of the terminal device to the MME during registration, so that the MME may determine whether the terminal device is in the management scope of the MME according to the location information, which may effectively guarantee communication reliability and communication quality of the terminal device.

Refer to FIG. 6, where FIG. 6 is a schematic structural diagram illustrating a communication apparatus provided in embodiments of the disclosure. The apparatus is applied to an MME and includes a determining unit 601 and a transmitting unit 602. The determining unit 601 is configured to determine first location information of a terminal device during registration. The transmitting unit 602 is configured to transmit registration accept information to the terminal device in the case where the first location information matches a management scope of the MME.

In some possible implementations, the apparatus further includes a receiving unit 603. The receiving unit 603 is specifically configured to receive, during registration, second location information of the terminal device transmitted by the terminal device. The determining unit 601 is specifically configured to determine the first location information of the terminal device according to the second location information.

In some possible implementations, the transmitting unit 602 is specifically configured to transmit a first service message to a location management entity. The first service message carries an uplink positioning container, and the uplink positioning container carries the second location information of the terminal device. The receiving unit 603 is specifically configured to receive a second service message transmitted by the location management entity. The second service message carries the first location information of the terminal device.

In some possible implementations, the receiving unit 603 is specifically configured to receive a first security message transmitted by the terminal device. The first security message carries the uplink positioning container, and the uplink positioning container carries the second location information of the terminal device.

In some possible implementations, the transmitting unit 602 is further configured to transmit a third service message to the location management entity. The third service message carries LCS information, and the LCS information indicates that the first location information of the terminal device is to be obtained. The receiving unit 603 is further configured to receive a fourth service message transmitted by the location management entity. The fourth service message carries a downlink positioning container, and the downlink positioning container carries assistance location information. The transmitting unit 602 is further configured to transmit a second security message to the terminal device. The second security message carries the downlink positioning container, and the downlink positioning container carries the assistance location information.

In some possible implementations, the receiving unit 603 is specifically configured to receive registration request information transmitted by the terminal device. The registration request information includes an uplink positioning container, and the uplink positioning container carries the second location information of the terminal device.

In some possible implementations, the first location information is MCC information for the terminal device. The receiving unit 603 is specifically configured to receive registration request information transmitted by the terminal device. The registration request information includes the MCC information for the terminal device.

In some possible implementations, the MCC information is obtained by monitoring broadcast information by the terminal device.

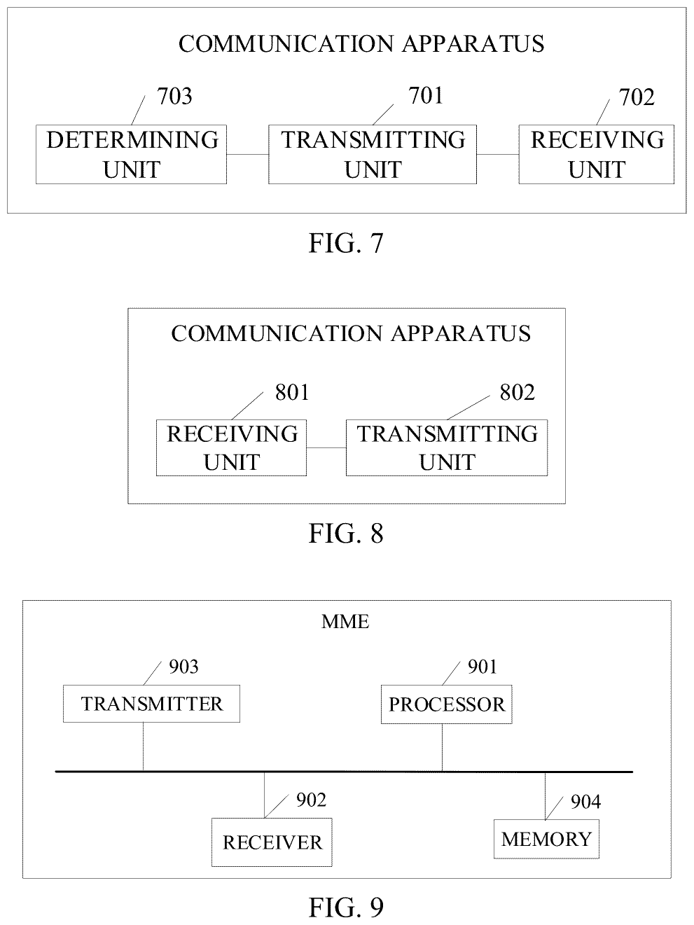

Refer to FIG. 7, where FIG. 7 is another schematic structural diagram illustrating a communication apparatus provided in embodiments of the disclosure. The method is applied to a terminal device and includes a transmitting unit 701 and a receiving unit 702. The transmitting unit 701 is configured to transmit first location information of the terminal device or second location information of the terminal device to an MME during registration. The first location information or the second location information is used to determine whether the first location information matches a management scope of the MME. The receiving unit 702 is configured to receive registration accept information transmitted by the MME.

In some possible implementations, the transmitting unit 701 is specifically configured to transmit a first security message to the MME. The first security message carries an uplink positioning container, and the uplink positioning container carries the second location information of the terminal device.

In some possible implementations, the receiving unit 702 is specifically configured to receive a second security message transmitted by the MME. The second security message carries a downlink positioning container, and the downlink positioning container carries assistance location information.

In some possible implementations, the transmitting unit 701 is specifically configured to transmit registration request information to the MME. The registration request information includes an uplink positioning container, and the uplink positioning container carries the second location information of the terminal device.

In some possible implementations, the terminal device stores a downlink positioning container, and the downlink positioning container carries assistance location information. The apparatus further includes a determining unit 703. The determining unit 703 is specifically configured to determine the second location information of the terminal device according to the assistance location information.

In some possible implementations, the first location information is MCC information for the terminal device, the transmitting unit 701 is specifically configured to transmit registration request information to the MME. The registration request information includes the MCC information.

In some possible implementations, the MCC information is obtained by sensing broadcast information by the terminal device.

Refer to FIG. 8, where FIG. 8 is yet another schematic structural diagram illustrating a communication apparatus provided in embodiments of the disclosure. The apparatus is applied to a location management entity and includes a receiving unit 801 and a transmitting unit 802. The receiving unit 801 is configured to receive a first service message transmitted by an MME. The first service message carries an uplink positioning container, and the uplink positioning container carries first location information of a terminal device. The transmitting unit 802 is configured to transmit a second service message to the MME. The second service message carries second location information of the terminal device.

In some possible implementations, the receiving unit 801 is further configured to receive a third service message transmitted by the MME. The third service message carries LCS information, and the LCS information indicates that the second location information of the terminal device is to be obtained. The transmitting unit 802 is further configured to transmit a fourth service message to the MME. The fourth service message carries a downlink positioning container, and the downlink positioning container carries assistance location information.

It may be understood that, in embodiments of the disclosure, the division of units is illustrative, and is only a division of logical functions, and other manners of division may be available in practice. Various functional units in embodiments of the disclosure may be integrated into one processing unit, or may be present as a number of physically separated units, or two or more units may be integrated into one. The integrated unit may be implemented in the form of hardware, or may be implemented in the form of a software functional unit.

Refer to FIG. 9, where FIG. 9 is a schematic structural diagram illustrating an MME provided in embodiments of the disclosure. The MME illustrated in FIG. 9 may include a processor 901, a receiver 902, a transmitter 903, and a memory 904. The processor 901, the receiver 902, the transmitter 903, and the memory 904 each are coupled with a bus. The memory 904 is configured to store computer programs, where the computer programs include program instructions. The processor 901 is configured to execute the program instructions stored in the memory 904.

In embodiments of the disclosure, the processor 901 is configured to execute executable program codes stored in the memory 904 to: determine first location information of a terminal device during registration; and transmit registration accept information to the terminal device in the case where the first location information matches a management scope of the MME.

In some possible implementations, the processor 901 is specifically configured to: receive, during registration, second location information of the terminal device transmitted by the terminal device; and determine the first location information of the terminal device according to the second location information.

In some possible implementations, the processor 901 is specifically configured to: transmit a first service message to a location management entity, where the first service message carries an uplink positioning container, and the uplink positioning container carries the second location information of the terminal device; receive a second service message transmitted by the location management entity, where the second service message carries the first location information of the terminal device; and transmit a second security message to the terminal device, where the second security message carries a downlink positioning container, and the downlink positioning container carries assistance location information.

In some possible implementations, the processor 901 is specifically configured to receive registration request information transmitted by the terminal device. The registration request information includes an uplink positioning container, and the uplink positioning container carries the second location information of the terminal device.

In some possible implementations, the first location information is MCC information for the terminal device. The processor 901 is specifically configured to receive registration request information transmitted by the terminal device. The registration request information includes the MCC information for the terminal device.

In some possible implementations, the MCC information is obtained by monitoring broadcast information by the terminal device.

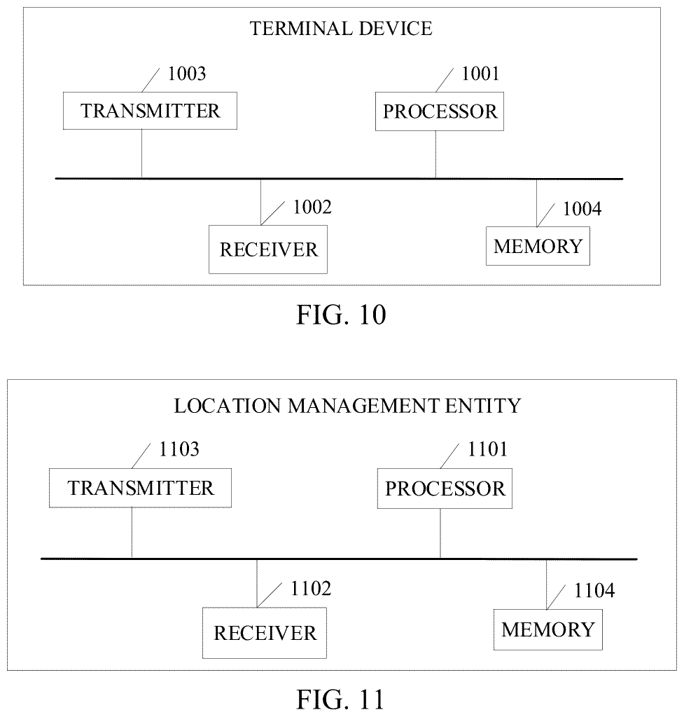

Refer to FIG. 10, where FIG. 10 is a schematic structural diagram illustrating a terminal device provided in embodiments of the disclosure. The terminal device illustrated in FIG. 10 may include a processor 1001, a receiver 1002, a transmitter 1003, and a memory 1004. The processor 1001, the receiver 1002, the transmitter 1003, and the memory 1004 each are coupled with a bus. The memory 1004 is configured to store computer programs, where the computer programs include program instructions. The processor 1001 is configured to execute the program instructions stored in the memory 1004.

In embodiments of the disclosure, the processor 1001 is configured to execute executable program codes stored in the memory 1004 to: transmit first location information of the terminal device or second location information of the terminal device to an MME during registration, where the first location information or the second location information is used to determine whether the first location information matches a management scope of the MME; and receive registration accept information transmitted by the MME.

In some possible implementations, the processor 1001 is specifically configured to transmit a first security message to the MME. The first security message carries an uplink positioning container, and the uplink positioning container carries the second location information of the terminal device.

In some possible implementations, the processor 1001 is further configured to receive a second security message transmitted by the MME. The second security message carries a downlink positioning container, and the downlink positioning container carries assistance location information.

In some possible implementations, the processor 1001 is specifically configured to transmit registration request information to the MME. The registration request information includes an uplink positioning container, and the uplink positioning container carries the second location information of the terminal device.

In some possible implementations, the terminal device stores a downlink positioning container, and the downlink positioning container carries assistance location information. The processor 1001 is further configured to determine the second location information of the terminal device according to the assistance location information.

In some possible implementations, the first location information is MCC information for the terminal device. The processor 1001 is specifically configured to transmit registration request information to the MME. The registration request information includes the MCC information.

In some possible implementations, the MCC information is obtained by sensing broadcast information by the terminal device.

Refer to FIG. 11, where FIG. 11 is a schematic structural diagram illustrating a location management entity provided in embodiments of the disclosure. The location management entity illustrated in FIG. 11 may include a processor 1101, a receiver 1102, a transmitter 1103, and a memory 1104. The processor 1101, the receiver 1102, the transmitter 1103, and the memory 1104 each are coupled with a bus. The memory 1104 is configured to store computer programs, where the computer programs include program instructions. The processor 1101 is configured to execute the program instructions stored in the memory 1104.

In embodiments of the disclosure, the processor 1101 is configured to execute executable program codes stored in the memory 1104 to: receive a first service message transmitted by an MME, where the first service message carries an uplink positioning container, and the uplink positioning container carries first location information of a terminal device; and transmit a second service message to the MME, where the second service message carries second location information of the terminal device.

In some possible implementations, the processor 1001 is further configured to: receive a third service message transmitted by the MME, where the third service message carries LCS information, and the LCS information indicates that the second location information of the terminal device is to be obtained; and transmit a fourth service message to the MME, where the fourth service message carries a downlink positioning container, and the downlink positioning container carries assistance location information.

Embodiments of the disclosure further provide a computer storage medium. The computer storage medium is configured to store program instructions which, when executed, may include some or all operations of the communication method in embodiments illustrated in FIG. 2, FIG. 3, FIG. 4, or FIG. 5.

Embodiments of the disclosure further provide a computer program product. The computer program product includes a non-transitory computer-readable storage medium storing computer programs. The computer programs are operable with a computer to implement some or all operations performed by the MME, the terminal device, or the location management entity described in the foregoing method embodiments. The computer program product may be a software installation package.

The steps of the method or algorithm described in embodiments of the disclosure may be implemented by means of hardware, or may be implemented by executing software instructions by a processor. The software instructions may be implemented by corresponding software modules, which can be stored in a random access memory (RAM), a flash memory, a read only memory (ROM), an erasable programmable ROM (EPROM), an electrically EPROM (EEPROM), a register, a hard disk, a mobile hard disk, a compact disc (CD)-ROM, or any other form of storage medium known in the art. An exemplary storage medium is coupled to the processor, such that the processor can read information from the storage medium and write information to the storage medium. The storage medium may also be a component of the processor. The processor and the storage medium may be located in an application-specific integrated circuit (ASIC). In addition, the ASIC may be located in a communication apparatus such as the terminal device. The processor and the storage medium may also be presented as discrete components in the communication apparatus.

It may be understood that, the “first”, “second”, and various numerical numbers involved in the disclosure are only intended for distinction for the convenience of illustration, rather than limiting the scope of the embodiments of the disclosure.

It may be understood that, in various embodiments of the disclosure, the magnitude of a sequence number of each process does not mean an order of execution, and the order of execution of each process may be determined by its function and an internal logic and shall not constitute any limitation to an implementation process of embodiments of the disclosure.

Those of ordinary skill in the art may understand that all or part of the processes of the methods in embodiments may be implemented by a computer program instructing relevant hardware. The program may be stored in a computer-readable storage medium. When the program is executed, the processes of the methods in embodiments are included. The foregoing storage medium includes an ROM, an RAM, a magnetic disk, an optical disc, or various mediums capable of storing program codes.

1. A communication method, the method being applied to a mobile management entity (MME) and comprising:
determining first location information of a terminal device during registration; and
transmitting registration accept information to the terminal device in a case where the first location information matches a management scope of the MME.

2. The method of claim 1, wherein determining the first location information of the terminal device during registration comprises:
receiving, during registration, second location information of the terminal device transmitted by the terminal device; and
determining the first location information of the terminal device according to the second location information.

3. The method of claim 2, wherein determining the first location information of the terminal device according to the second location information comprises:
transmitting a first service message to a location management entity, wherein the first service message carries the second location information of the terminal device; and
receiving a second service message transmitted by the location management entity, wherein the second service message carries the first location information of the terminal device.

4. The method of claim 3, wherein receiving the second location information of the terminal device transmitted by the terminal device comprises:
receiving a first security message transmitted by the terminal device, wherein the first security message carries the second location information of the terminal device.

5. The method of claim 4, wherein before receiving the first security message transmitted by the terminal device, the method further comprises:
transmitting a third service message to the location management entity, wherein the third service message carries location service (LCS) information, and the LCS information indicates that the first location information of the terminal device is to be obtained;
receiving a fourth service message transmitted by the location management entity, wherein the fourth service message carries assistance location information; and
transmitting a second security message to the terminal device, wherein the second security message carries the assistance location information.

6-17. (canceled)

18. A mobile management entity (MME) comprising:
a transceiver;
a processor coupled to the transceiver; and
a memory storing a computer program which, when executed by the processor, causes the MME to:
determine first location information of a terminal device during registration; and
transmit registration accept information to the terminal device in a case where the first location information matches a management scope of the MME.

19. A terminal device comprising:
a transceiver;
a processor coupled to the transceiver; and
a memory storing a computer program which, when executed by the processor, causes the terminal device to:
transmit first location information of the terminal device to a mobile management entity (MME) during registration, the first location information being used to determine whether the first location information matches a management scope of the MME; and
receive registration accept information transmitted by the MME.

20-24. (canceled)

25. The method of claim 2, wherein the first location information is a mobile country code, and the second location information is latitude and longitude of the terminal device.

26. The method of claim 5, wherein the first security message is a security mode complete message.

27. The MME of claim 18, wherein the computer program executed by the processor to cause the MME to determine the first location information of the terminal device during registration is executed by the processor to cause the MME to:
receive, during registration, second location information of the terminal device transmitted by the terminal device; and
determine the first location information of the terminal device according to the second location information.

28. The MME of claim 27, wherein the first location information is a mobile country code, and the second location information is latitude and longitude of the terminal device.

29. The MME of claim 27, wherein the computer program executed by the processor to cause the MME to determine the first location information of the terminal device according to the second location information is executed by the processor to cause the MME to:
transmit a first service message to a location management entity, wherein the first service message carries the second location information of the terminal device; and
receive a second service message transmitted by the location management entity, wherein the second service message carries the first location information of the terminal device.

30. The MME of claim 29, wherein the computer program executed by the processor to cause the MME to receive the second location information of the terminal device transmitted by the terminal device is executed by the processor to cause the MME to:
receive a first security message transmitted by the terminal device, wherein the first security message carries the second location information of the terminal device.

31. The MME of claim 30, wherein the first security message is a security mode complete message.

32. The MME of claim 30, wherein the computer program is further executed by the processor to cause the MME to performing the following before receiving the first security message transmitted by the terminal device:
transmitting a third service message to the location management entity, wherein the third service message carries location service (LCS) information, and the LCS information indicates that the first location information of the terminal device is to be obtained;
receiving a fourth service message transmitted by the location management entity, wherein the fourth service message carries assistance location information; and
transmitting a second security message to the terminal device, wherein the second security message carries the assistance location information.

33. The terminal device of claim 19, wherein the computer program is further executed by the processor to cause the terminal device to:
transmit second location information of the terminal device to the MME during registration, wherein the second location information is used to determine the first location information of the terminal device.

34. The terminal device of claim 33, wherein the first location information is a mobile country code, and the second location information is latitude and longitude of the terminal device.

35. The terminal device of claim 33, wherein the computer program executed by the processor to cause the terminal device to transmit the second location information of the terminal device to the MME is executed by the processor to cause the terminal device to:
transmit a first security message to the MME, wherein the first security message carries the second location information of the terminal device.

36. The terminal device of claim 35, wherein the first security message is a security mode complete message.

37. The terminal device of claim 35, wherein the computer program is further executed by the processor to cause the terminal device to perform the following before transmitting the first security message to the MME:
receiving a second security message from the MME, wherein the second security message carries assistance location information.
